(19) United States
(12) Patent Application Publication
(10) Pub. No.: US 2016/0275357 A1
(43) Pub. Date: Sep. 22, 2016

(54) METHOD AND SYSTEM FOR TRACKING A REGION IN A VIDEO IMAGE

(71) Applicants: RAMOT AT TEL-AVIV UNIVERSITY LTD., Tel-Aviv (IL); TEL HASHOMER MEDICAL RESEARCH INFRASTRUCTURE AND SERVICES LTD., Ramat-Gan (IL)

(72) Inventors: Shahar GINO, Haifa (IL); Hedva SPITZER, Tel-Aviv (IL); Eli KONEN, Tel-Aviv (IL); Orly GOITEIN, Kiryat-Ono (IL)

(21) Appl. No.: 15/035,313

(22) PCT Filed: Nov. 19, 2014
(86) PCT No.: PCT/IL2014/051009

§ 371 Date: May 9, 2016

Related U.S. Application Data
(60) Provisional application No. 61/905,965, filed on Nov. 19, 2013.

(51) Int. Cl. G06K 9/00; G06T 7/00; G06T 3/00; G06K 9/52; G06K 9/62; G06T 7/20; G06K 9/46

(52) U.S. Cl. CPC G06K 9/00771; G06T 7/20; G06K 9/00335; G06T 7/0085; G06K 9/4604; G06K 9/52; G06K 9/6215; G06T 3/0006

(57) ABSTRACT

A method of tracking a region in a video image having a plurality of video frames is disclosed. The method comprises: generating one or more candidate contours in a video frame; and, for each candidate contour, analyzing the candidate contour based on intensity values of picture-elements along the candidate contour, and analyzing an area at least partially enclosed by the candidate contour based on texture features in the area. The method further comprises selecting a winner contour from the candidate contour(s) based on the analyses, and associating the region with the winner contour.

### RELATED APPLICATION

This application claims the benefit of priority of U.S. Provisional Patent Application No. 61/905,965 filed Nov. 19, 2013, the contents of which are incorporated herein by reference in their entirety.

### FIELD AND BACKGROUND OF THE INVENTION

The present invention, in some embodiments thereof, relates to image processing and, more particularly, but not exclusively, to a method and system for tracking a region in a video image.

It is often desirable to track an object across a sequence of frames in a video. However, object tracking can be challenging due to occlusions and variations in appearance of the object. Numerous approaches to object tracking and recognition have been proposed. Some approaches establish a boundary that separates the object from the background in each frame, other approaches use the boundary to define a shape and track the centre of the shape.

One approach to object tracking, called Eigentracking, is described in Black et al., “Eigentracking: Robust Matching and Tracking of Articulated Objects Using a View-Based Representation,” 1996, ECCV. Eigentracking uses a predefined model of an object, such as a face, being tracked. The model encompasses a range of variations of the object being tracked. Incremental visual tracking (IVT) can track an object without a predefined model. IVT is described in Ross et al., “Incremental Learning for Robust Visual Tracking,” 2007, IJCV. IVT starts with an initial location of an object, and builds its model as the object is tracked across more frames.

Traditional methods assume prominent features such as chromatic characteristics, sharp contour, constant brightness, motion's component and unique texture [Zhu et al., 2010, “Object Tracking in Structured Environments for Video Surveillance Applications”, IEEE Transactions on Circuits and Systems for Video Technology, 20; Weng et al., 2006, “Video object tracking using adaptive Kalman filter,” Journal of Visual Communication and Image Representation, 17, 1190-1208; Suryanto et al., 2011, “Spatial color histogram based center voting method for subsequent object tracking and segmentation,” Image and Vision Computing, 29, 850-860].

Medical studies which relate to tracking and/or stabilizing of cardiac videos focus on the left ventricle. Some apply video processing methods [Colantonio et al., 2005, “MRI left ventricle segmentation and reconstruction for the study of the heart dynamics,” Proceedings of the Fifth IEEE International Symposium on Signal Processing and Information Technology, 2005; Kaus et al., 2004, “Automated segmentation of the left ventricle in cardiac MRI,” Medical Image Analysis, 8, 245-254; Hui Wang, & Amini, A. A, 2012, “Cardiac Motion and Deformation Recovery From MRI: A Review,” IEEE Transactions on Medical Imaging].

Additional studies are based on a designated motion model which are developed due to theoretical assumptions on the heart motion [Bogatyrenko et al., 2011, “Visual stabilization of beating heart motion by model-based transformation of image sequences,” Proceedings of the 2011 American Control Conference, 5432-5437; Shechter et al., 2004, “Respiratory motion of the heart from free breathing coronary angiograms,” IEEE transactions on medical imaging Vol. 23, pp. 1046-1056; Burger, I., & Meintjes, E. M, 2012, “Elliptical subject-specific model of respiratory motion for cardiac MRI,” Magn. Reson. Med., 000, 1-10; Ventura et al., 2010, “Bilinear point distribution models for heart motion analysis,” Biomedical Imaging: From Nano to Macro, 2010 IEEE International Symposium on].

Additional background art includes Cannons, K, 2008, A Review of Visual Tracking, Engineering, 242.

### SUMMARY OF THE INVENTION

According to an aspect of some embodiments of the present invention there is provided a method of tracking a region in a video image, the video image having a plurality of video frames. The method comprises: receiving an initial contour defining the region in a first video frame of the video image; and performing the following operations for each video frame F other than the first video frame: generating at least one candidate contour in the video frame F; for each candidate contour, analyzing the candidate contour based on intensity values of picture-elements along the candidate contour, and analyzing an area at least partially enclosed by the candidate contour based on texture features in the area; and selecting a winner contour from the at least one candidate contour based on the analyses, and associating the region with the winner contour.

According to some embodiments of the invention the generation of at least one candidate contour comprises geometrically manipulating a contour defining the region in a previous video frame.

According to some embodiments of the invention the analysis of the at least one candidate contour based on intensity values comprises calculating a shape score based on a neighborhood of the candidate contour.

According to some embodiments of the invention the calculation of the shape score comprises rescaling the candidate contour at least once to provide at least one rescaled version of the candidate contour, and assigning a weight to each rescaled version or combination of rescaled versions.

According to some embodiments of the invention the analysis of the area comprises calculating a similarity score based on similarity between the area and an area at least partially enclosed by a contour defining the region in the previous video frame.

According to some embodiments of the invention the method further comprises calculating affine transformation describing a change of the region relative to a previous video frame, the change being indicative of a motion of the region.

According to some embodiments of the invention the invention the method comprises generating a shrunk version and an expanded version of the winner contour, and analyzing the shrunk and the expanded versions so as to correct errors in the winner contour.

According to some embodiments of the invention the selection of winner contour comprises generating an ordered list of shape scores and an ordered list of similarity scores, combining the lists, and selecting contour parameters that maximize the combined list.

According to an aspect of some embodiments of the present invention there is provided a method of tracking a region in a video image, the video image having a plurality of video frames. The method comprises: receiving an initial contour defining the region in a first video frame of the video image; and performing the following operations for each video frame F other than the first video frame: geometrically manipulating a contour defining the region in a previous video frame to provide at least one contour candidate; for each candidate contour, independently calculating a shape score based on a neighborhood of the candidate contour, and a similarity score based on similarity between an interior of the contour in the previous video frame and an interior of the candidate contour; and selecting a winner contour for the video frame F based on the shape score and the similarity score, and associating the region with the winner contour.

According to some embodiments of the invention the method comprises calculating affine transformation describing a change of the region relative to the previous video frame, the change being indicative of a motion of the region.

According to some embodiments of the invention the method further comprises compensating the video frame F for the motion.

According to some embodiments of the invention the affine transformation is characterized by a rotation, translation and rescaling.

According to some embodiments of the invention the compensation comprises executing an inverse affine transformation with respect to the rotation, and the translation, but not the rescaling.

According to some embodiments of the invention the method comprises generating a shrunk version and an expanded version of the winner contour, and analyzing the shrunk and the expanded versions so as to correct errors in the winner contour.

According to some embodiments of the invention the calculation of the shape score comprises rescaling the candidate contour at least once to provide at least one rescaled version of the candidate contour, and assigning a weight to each rescaled version or combination of rescaled versions.

According to some embodiments of the invention the selection of the winner contour comprises generating an ordered list of shape scores and an ordered list of similarity scores, combining the lists, and selecting contour parameters that maximize the combined list.

According to some embodiments of the invention the method comprises weighting the lists prior to the combination. According to some embodiments of the invention the weighting is based on variances of scores in the lists.

According to some embodiments of the invention the image is an achromatic image. According to some embodiments of the invention the image is an image acquired by a medical imaging system. According to some embodiments of the invention the image is an MRI image. According to some embodiments of the invention the image is of at least one type selected from the group consisting of a visible light image, an X-ray image, a thermal image, a ultraviolet image, a computerized tomography (CT) image, a mammography image, a Roentgen image, a positron emission tomography (PET) image, a magnetic resonance image, an ultrasound image, an impedance image, and a single photon emission computed tomography (SPECT) image. According to some embodiments of the invention the image is a cardiac MRI perfusion image, and the region is a heart.

According to an aspect of some embodiments of the present invention there is provided a computer software product. The computer software product comprises a computer-readable medium in which program instructions are stored, which instructions, when read by a computer, cause the computer to execute the method as delineated above and optionally as further exemplified below.

According to an aspect of some embodiments of the present invention there is provided a system for processing an image, the system comprises a data processor configured for executing the method as delineated above and optionally as further exemplified below.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE DRAWINGS

Some embodiments of the invention are herein described, by way of example only, with reference to the accompanying drawings and images. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a flowchart diagram describing a method suitable for tracking a region in a video image, according to some embodiments of the present invention;

FIG. 2 is a diagram describing the method in embodiments in which one or more additional operations are executed;

FIG. 3 is a schematic illustration of a data processing system according to some embodiments of the present invention;

FIGS. 4A-D show several sequences of a CMRI perfusion image, also known as TC-Short-Axis;

FIGS. 5A-B are schematic illustrations depicting an image processing apparatus scheme employed in experiments performed according to some embodiments of the present invention;

FIG. 6 shows a scaled-in and a scaled-out versions of a candidate contour generated in experiments performed according to some embodiments of the present invention;

FIG. 7 is a schematic illustration showing four filters A, B, C and D, and four respective weights W_{A}, W_{B}, W_{C} and W_{D}, used in experiments performed according to some embodiments of the present invention;

FIG. 8 shows shrunk and expanded versions of a winner contour, as generated in experiments performed according to some embodiments of the present invention;

FIG. 9 is a schematic illustration showing a temporal filtering employed in experiments performed according to some embodiments of the present invention;

FIG. 10 is a schematic illustration of a procedure suitable for selecting rotation candidate, as employed in experiments performed according to some embodiments of the present invention;

FIG. 11 shows a set of CMRI videos introduced to radiologists during experiments performed according to some embodiments of the present invention;

FIGS. 12A and 12B show mean Inter Frame Similarity (FIG. 12A) and mean Structural Similarity (FIG. 12B), as obtained in experiments performed according to some embodiments of the present invention;

FIGS. 13A and 13B show clinical assessment results obtained in experiments performed according to some embodiments of the present invention; and

FIGS. 14A and 14B show engineering stability gains obtained in experiments performed according to some embodiments of the present invention.

### DESCRIPTION OF SPECIFIC EMBODIMENTS OF THE INVENTION

The present invention, in some embodiments thereof, relates to image processing and, more particularly, but not exclusively, to a method and system for tracking a region in a video image.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

The present embodiments are concerned with method and system for processing a video image. At least part of the processing can be implemented by a data processing system, e.g., a dedicated circuitry or a general purpose computer, configured for receiving the image and executing the operations described below.

The method of the present embodiments can be embodied in many forms. For example, it can be embodied in on a tangible medium such as a computer for performing the method operations. It can be embodied on a computer readable medium, comprising computer readable instructions for carrying out the method operations. In can also be embodied in electronic device having digital computer capabilities arranged to run the computer program on the tangible medium or execute the instruction on a computer readable medium.

Computer programs implementing the method of the present embodiments can commonly be distributed to users on a distribution medium such as, but not limited to, a CD-ROM, a flash memory device and a portable hard drive. The distribution medium can also be a cloud facility or a network drive. From the distribution medium, the computer programs can be copied to a hard disk or a similar intermediate storage medium. The computer programs can be run by loading the computer instructions either from their distribution medium or their intermediate storage medium into the execution memory of the computer, configuring the computer to act in accordance with the method of this invention. All these operations are well-known to those skilled in the art of computer systems.

The image to be analyzed using the teachings of the present embodiments is generally in the form of imagery data arranged gridwise in a plurality of picture-elements (e.g., pixels, group of pixels, etc.).

The term “pixel” is sometimes abbreviated herein to indicate a picture-element. However, this is not intended to limit the meaning of the term “picture-element” which refers to a unit of the composition of an image.

References to an “image” herein are, inter alia, references to values at picture-elements treated collectively as an array. Thus, the term “image” as used herein also encompasses a mathematical object which does not necessarily correspond to a physical object. The original and processed images certainly do correspond to physical objects which are the scene from which the imaging data are acquired.

Each pixel in the image can be associated with a single digital intensity value, in which case the image is a grayscale image. Alternatively, each pixel is associated with three or more digital intensity values sampling the amount of light at three or more different color channels (e.g., red, green and blue) in which case the image is a color image. Also contemplated are images in which each pixel is associated with a mantissa for each color channels and a common exponent (e.g., the so-called RGBE format). Such images are known as “high dynamic range” images.

The image to be analyzed according to some embodiments of the present invention is a video image, which may include a plurality of time-dependent values (e.g., grey-levels, intensities, color intensities, etc.), wherein a particular value at a particular time-point corresponds to a picture-element (e.g., a pixel, a sub-pixel or a group of pixels) in a video frame. In some embodiments, the video image is an achromatic video image. In some embodiments of the present invention the video image is an image acquired by a medical imaging system.

Representative examples of video images suitable for being analyzed according to some embodiments of the present invention include, without limitation, an MRI image, an X-ray image, a thermal image, a ultraviolet image, a computerized tomography (CT) image, a mammography image, a Roentgen image, a positron emission tomography (PET) image, an ultrasound image, an impedance image, and a single photon emission computed tomography (SPECT) image. In some embodiments of the present invention the video image is an MRI video image, and in some embodiments of the present invention the video image is a cardiac MRI perfusion image.

It is expected that during the life of a patent maturing from this application many relevant imaging modalities will be developed and the scope of the term video image is intended to include all such new technologies a priori.

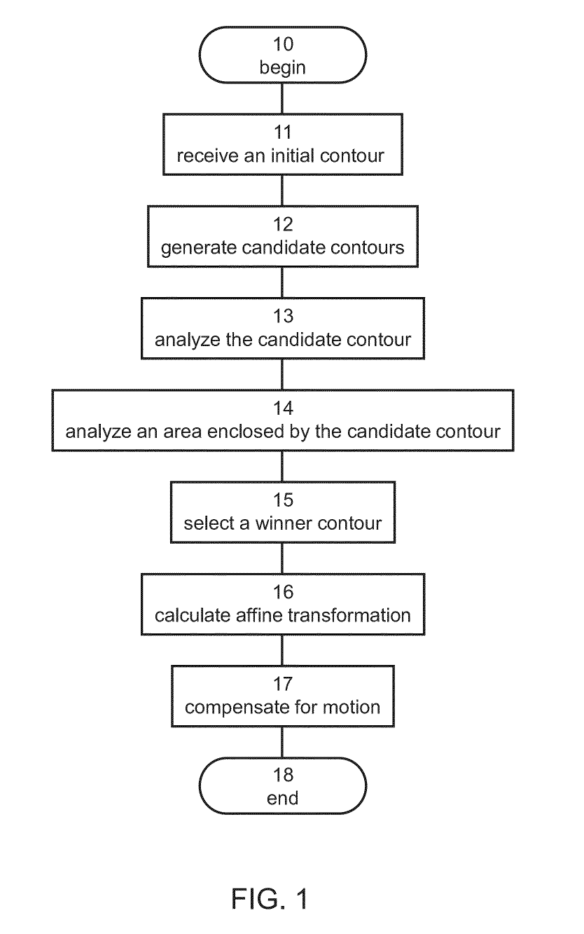

FIG. 1 is a flowchart diagram describing a method suitable for tracking a region in a video image, according to some embodiments of the present invention. It is to be understood that, unless otherwise defined, the operations described hereinbelow can be executed either contemporaneously or sequentially in many combinations or orders of execution. Specifically, the ordering of the flowchart diagrams is not to be considered as limiting. For example, two or more operations, appearing in the following description or in the flowchart diagrams in a particular order, can be executed in a different order (e.g., a reverse order) or substantially contemporaneously. Additionally, several operations described below are optional and may not be executed.

The method begins at 10 and continues to 11 at which an initial contour defining the region in a first video frame of the video image is received. The initial contour can be provided, for example, as a set of coordinates describing a plurality of points along the initial contour. The initial contour can also be provided by a user, for example, using a display device and a user interface that allows defining contours on displayed images.

The term “contour” as used herein refers to a one-dimensional curved line, which is preferably a closed line.

The frame on which the initial contour is defined can be the very first frame of the video image (e.g., the “time zero” frame), but this need not necessarily be the case, since, for some applications, it may be desired to define the contour on the nth frame of the video image, were n>0. Thus the term “first frame” as used herein means the frame on which the initial contour is defined, and not necessarily the first frame of the video image.

The following operations are repeated for one or more frames of the video image other than the first frame. Optionally and preferably, the following operations are repeated for all the frames of the video image other than the first frame. The operations are performed iteratively, wherein the processing of a particular frame depends on the outcome of the processing of a previous frame.

The currently processed frame is referred to as frame F.

The method optionally and preferably continues to 12 at which one or more candidate contours are generated in video frame F. The candidate contours can be generated, for example, by geometrically manipulating a contour defining the region in a previous video frame. Representative examples of geometrical manipulations are provided below.

The method optionally and preferably continues to 13 at which the candidate contour is analyzed based on intensity values of picture-elements along candidate contour. Such an analysis can include, for example, calculation of a shape score based on a neighborhood of candidate contour. Representative examples of procedures for calculating a shape score are provided below.

The method optionally and preferably continues to 14 at which an area at least partially enclosed by the candidate contour is analyzed based on texture features in the area. Such an analysis can include, for example, calculation of a texture similarity score based on similarity between area and an area at least partially enclosed by a contour defining the region in previous video frame. Representative examples of procedures for calculating a texture similarity score are provided below.

Operations 13 and 14 are preferably executed separately and independently for each candidate contour. In various exemplary embodiments of the invention operations 13 and 14 are executed independently from each other.

The method optionally and preferably proceeds to 15 at which a winner contour is selected from the candidate contour(s) based on the analyses. The region at video frame F is then optionally and preferably associated with the winner contour. The winner contour can be selected by combining an ordered list of shape scores with an ordered list of similarity scores, and selecting contour parameters that maximize the combined list. Representative examples of procedures for selecting a winner contour are provided below.

In some embodiments of the present invention the method continues to 16 at which the method calculates an affine transformation describing a change of the region relative to a previous video frame, and to 17 at which the method employs a motion compensation procedure to video frame F. Representative examples of procedures for calculating an affine transformation and for a motion compensation procedure are provided below.

The method ends at 18.

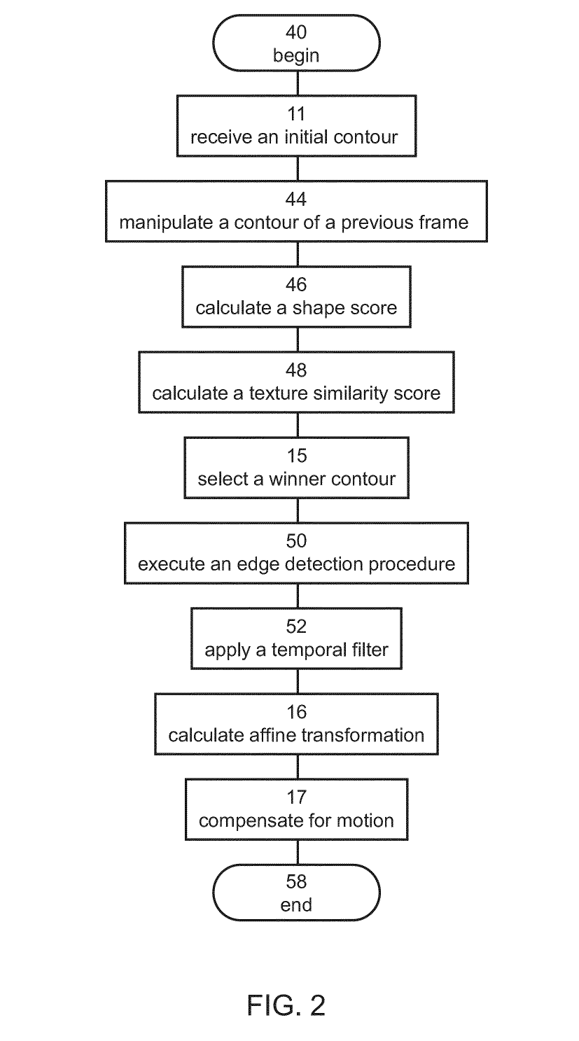

FIG. 2 is a flowchart diagram describing the method in embodiments in which one or more additional operations are executed. The method begins at 40 and continues to 11 at which an initial contour defining the region in a first video frame of the video image is received, as further detailed hereinabove. The following operations are repeated for one or more frames of the video image other than the first frame. Optionally and preferably, the following operations are repeated for all the frames of the video image other than the first frame. The operations are performed iteratively, wherein the processing of a particular frame depends on the outcome of the processing of a previous frame.

The currently processed frame is referred to as frame F.

The method continues to 44 at which a contour defining the region in a previous video frame is geometrically manipulated to provide at least one contour candidate in the current frame F. The previous video frame is preferably, but not necessarily, the video frame that immediately precedes frame F. The geometric manipulation includes at least one or at least two types of manipulation selected from the group consisting of translation, rotation and rescaling. Preferably, the manipulation includes translation, and rotation and rescaling.

Each type of manipulation is characterized by one or more parameters, which correspond to the direction and extent of the manipulation. Thus, for example, a translation can be characterized by a linear extend dL and a direction dφ, or, equivalently, by two offset extents, e.g., an offset dX along the X direction and an offset dY along the Y direction. A rotation can be characterized by an angular extent θ and an angular direction (clockwise or counterclockwise), or, equivalently an angular extent θ and a sign (e.g., positive to counterclockwise rotation and negative to clockwise). A scaling can be characterized by a dimensionless parameter S which defines the ratio between the size of the manipulated contour to the size of the contour of the previous frame, wherein the size of the contour can be the overall length of the respective contour or the area of the region enclosed or partially enclosed by the respective contour. A mathematical formulation for defining a candidate contour using the parameters dX, dY, θ and S is provided in the Examples section that follows (see EQ. 1.3).

The number of candidate contours depends on the number of manipulations performed. Preferably the number of candidate contours is preselected. For example, suppose that the method employs n₁ different values for dX, n₂ different values for dY, n₃ different values for θ, and n₄ different values for S. In these embodiments, there are n₁×n₂×n₃×n₄ candidate contours.

The method continues to 46 and 48 at which two or more scores are calculated for each candidate contour. At least two of these scores are calculated independently from each other.

As used herein, “independent calculations” refers to two or more calculations for which the result of any of these calculations does not change as a function of the result of the other calculations.

In various exemplary embodiments of the invention the scores include a shape score (block 46) and a texture similarity score (block 48). The shape score is optionally and preferably based on a neighborhood of the candidate contour. Specifically, higher score is assigned when the likelihood that the contour of the region is within a neighborhood of the candidate contour is higher, and lower score is assigned otherwise. The likelihood is determined based on the characteristics of the region enclosed by the contour of the previous frame. For example, when the region enclosed by the contour of the previous frame is brighter than the background, then higher likelihood values are assigned to brighter picture-elements, when the region enclosed by the contour of the previous frame is darker than the background, then higher likelihood values are assigned to darker picture-elements, when the region enclosed by the contour of the previous frame is characterized by a particular color or set of colors than the background, then higher likelihood values are assigned to picture-elements storing the particular color or set of colors.

The neighborhood is optionally and preferably of predetermined size relative to the candidate contour. A neighborhood can be defined, for example, by defining a group of nearby pixels for each pixel p along the candidate contour. The group of nearby pixels preferably also includes the pixel p itself. The group of nearby pixels typically includes 9-225 pixels. In experiments performed by the present inventors, an 11×11 square of pixels was used, but other numbers of pixels in the group are also contemplated.

In a preferred embodiment, the shape score calculation includes an operation in which the candidate contour is rescaled at least once to provide at least one rescaled version of the candidate contour. Thereafter, a weight can be assigned to each rescaled version or combination of rescaled versions. For example, one or more scaled-in and one or more scaled-out versions of the candidate contour can be generated. These scaled-in and scaled-out versions can be used for determining the likelihood that the contour of the region is within a neighborhood of the candidate contour, wherein the area between the scaled-in and scaled-out versions is considered as the neighborhood of the candidate contour. The weight can be assigned based on the likelihood that the contour of the region is between the scaled-in and scaled-out versions.

Also contemplated, are embodiments in which both groups of nearby pixels are defined for each pixel, and scaled-in and scaled-out versions of the candidate contours are generated. A representative example of a procedure suitable for calculating a shape score according to these embodiments is provided in the Examples section that follows (see, e.g., EQ. 1.5).

The texture similarity score is optionally and preferably calculated based on the similarity between an interior area enclosed or partially enclosed by the contour in the previous video frame and an interior area enclosed or partially enclosed by the candidate contour. The texture similarity score calculation is preferably preceded by registration of coordinates of the current frame F with respect to the previous frame. Preferably, the similarity between the areas is with respect to textures within the areas. In various exemplary embodiments of the invention the similarity is determined using linear estimation, wherein the texture is determined by identifying lines within the respective area. Representative examples of similarity measures suitable for the present embodiments including, without limitation, Sum of Squared Differences (SSD) based on mean squared error (MSE), Multi-scale Structural Similarity (MSSIM), and Mutual Information (MI). These measures are known and found, for example, in Sebe et al., Pattern Analysis and Machine Intelligence, IEEE Transactions on 22.10 (2000): 1132-1143; Rouse et al., 2008, 15th IEEE International Conference on Image Processing; and Walters-Williams et al., 2009, Estimation of Mutual Information: A Survey. Rough Sets and Knowledge Technology, 5589, 389-396. doi:10.1007/978-3-642-02962-2 49, the contents of which are hereby incorporated by reference.

The similarity can also be calculated using an oriented multi scale filter, as taught, for example, in International Publication Nos. WO2009/057106, WO2011/045784, and WO2012/017440, the contents of which are hereby incorporated by reference.

The similarity between the two regions can also be analyzed using a weighting mask based on a range filter. A range filter assigns greater coefficients to neighboring pixels with light intensity that is more similar to the center pixel value. In some embodiments, the range filter replaces the intensity value of each pixel p by the difference between the maximal intensity value and the minimal intensity value over a group G of pixels containing pixel p. The group G can contain any number of pixels. Preferably the group G defines an area in which the pixel p recedes generally on its center. For example, the group G can be an a×a square of pixels, where a is selected from the group consisting of 3, 5, 7, 8, 9, 11, 13 and 15 and wherein the pixel p is at the center of the square.

The method continues to 15 at which a winner contour is selected for video frame F, based, at least in part, on the shape score the texture similarity score. The method then associates the region with the selected winner contour. The winner contour is optionally and preferably can be selected by considering all the scores calculated for all candidate contours. For example, an ordered list of shape scores and an ordered list of similarity scores can be generated. Thereafter, the two lists can be combined, and contour parameters that maximize the combined list can be selected. In some embodiments of the present invention the lists are weighted prior to their combination. Preferably, the weighting is based on variances of scores in the lists. For example, denoting the ordered list of shape scores by SB_SA={SA₁, SA₂, . . . , SA_{N}} and the ordered list of texture similarity scores by SB_IFS={IFS₁, IFS₂, . . . , IFS_{N}}, where SA₁≧SA₂ . . . ≧SA_{N}, and IFS₁≧IFS₂ . . . ≧IFS_{N}, the combined list can be W(1)SA₁, W(1)SA₂, . . . , W(1)SA_{N}, W(2)IFS₁, W(2)IFS₂, . . . , W(2)IFS_{N}}, where W(1) and W(2) are weights calculated based on variances in each of the lists SB_SA and SB_IFS. The contour parameters can then be selected by searching for the set of contour parameter (e.g., the parameters dX, dY, θ and S) that maximizes combined list.

A preferred expression for calculating W(1) is w₁|SA₂−SA₁|+w₂|SA₃−SA₂|+ . . . +wₘ|SAₘ₊₁−SAₘ|, and a preferred expression for calculating W(2) is w₁|IFS₂−IFS₁|+w₂|IFS₃−IFS₂|+ . . . +wₘ|IFSₘ₊₁−IFSₘ|, where m<N is a predetermined integer and w₁, w₂, . . . , wₘ is a set of predetermined weight parameters. Typically, but not necessarily, the weight parameters are descending, namely w₁>w₂ . . . >wₘ. For example, weight parameters can form a decreasing geometric series, such that w₁/w₂= . . . =wₘ₋₁/wₘ>1. In experiments performed by the present inventors, m was set to be 3 and the weight parameters were set to be w₁=4, w₂=2, w₃=1. This selection is equivalent to Algorithm 1 in the Examples section that follows.

In some embodiments of the present invention the method continues to 50 at which an edge detection procedure is employed so as to correct errors in winner contour. The present inventors found that the boundaries of the region at the current frame can be determined by a small variation from the winner contour. Thus, according to some embodiments of the present invention operation 50 is executed by rescaling the winner contour to generate at least one shrunk version and at least one expanded version of the winner contour, and analyzing the shrunk and expanded versions so as to correct errors in winner contour. The shrunk and expanded versions are generated in a similar manner as explained above with respect to the shape score calculation, except that in 50 they are generated for the winner contour wherein the aforementioned shape score calculation is executed for the candidate contour(s).

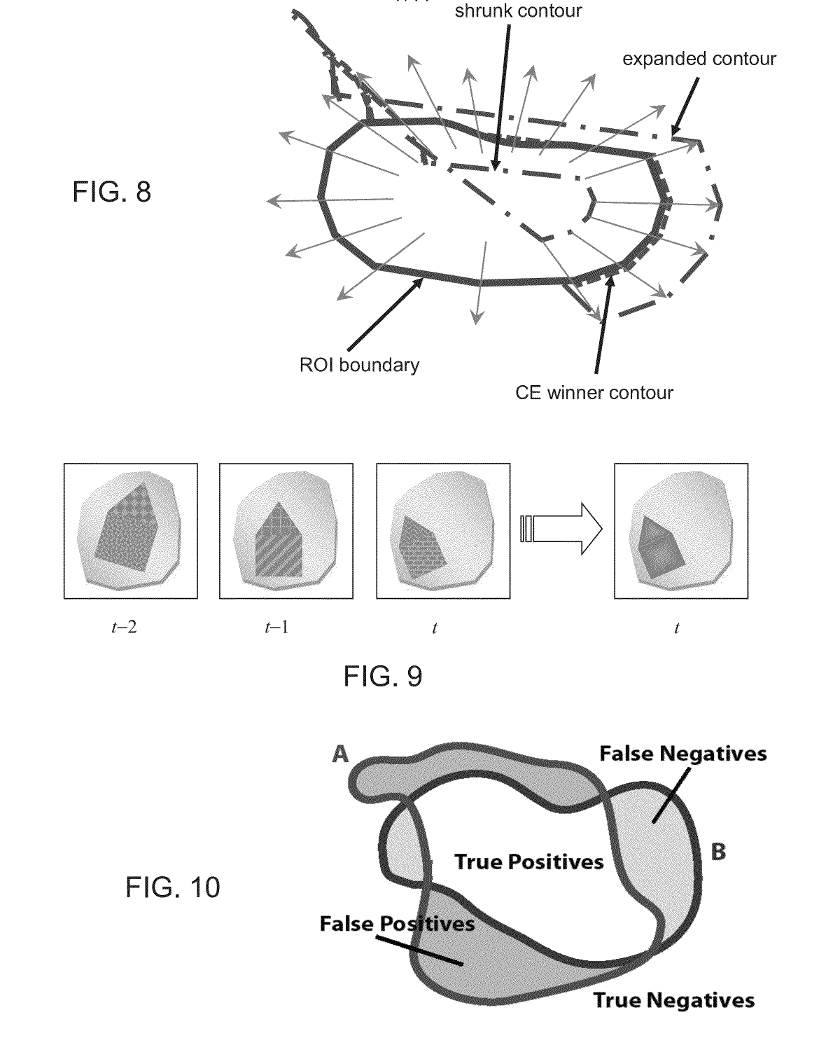

Shrunk and expanded versions of a winner contour are illustrated in FIG. 8 of the Examples section that follows. Once the shrunk and expanded versions are generated the boundary of the region can be searched along paths which connect the shrunk and expanded versions and are generally perpendicular thereto. It was found by the present inventors that such a procedure provides a computationally fast tool which respects orientations, since deformations are searched perpendicular to the winner contour. Optionally, the method proceeds to 52 at which a temporal filtering is employed so as to smooth textural interior patches.

In some embodiments of the present invention the method continues to 16 at which an affine transformation describing a change of the region relative to the previous video frame is calculated. The change can be with respect to orientation, position and/or scale, and is therefore indicative of a motion of the region between the previous and current frames. The affine transformation is applied to the winner contour. In embodiments in which 50 is executed, the affine transformation is applied to the winner contour after the correction. A representative example of a procedure for calculating the affine transformation is provided in the Examples section that follows (see EQs. 1.8-1.10).

The advantage of estimating the motion of the region is that it allows stabilizing the video image. When the image is a medical image, such stabilization reduces or prevents motion interferences organs nearby the region. Video stabilization can be achieved, for example, by compensating for the motion of the region so that at least one contour parameter (e.g., at least one parameter selected from the group consisting of dX, dY, θ and S) remains generally constant (e.g., with variation of less than 10% or less than 5% or less than 1%).

Thus, according to some embodiments of the present invention the method proceeds to 17 at which video frame F is at least partially compensated for the motion of the region. This is optionally and preferably done by executing an inverse affine transformation with respect to at least one of the contour parameters. In some embodiments, the compensation is with respect to the offset (e.g., the parameters dX and dY) and with respect to the rotation (e.g., the parameter θ), but not with respect to the rescaling parameter. These embodiments are particularly preferred when the region describes the heart of an individual, and it is desired not to remove changes that are derived from heartbeats, which affect the scale of the heart.

The method ends at 58.

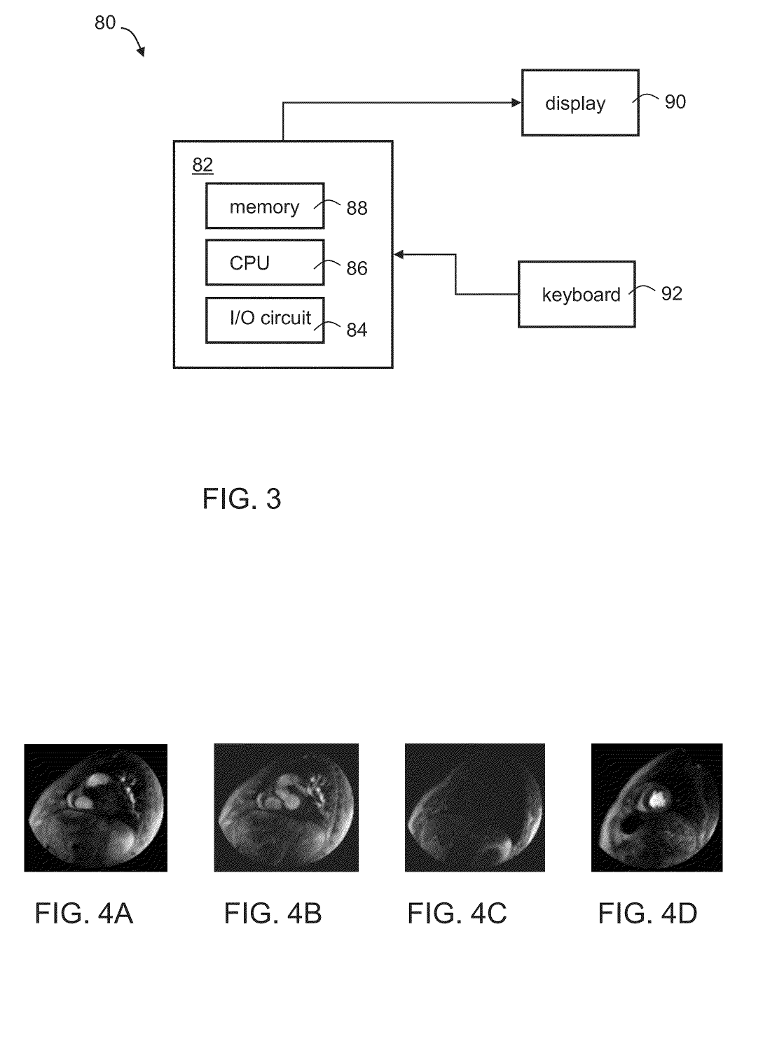

FIG. 3 is a schematic illustration of a data processing system 80 according to some embodiments of the present invention. System 80 comprises a computer 82, which typically comprises an input/output (I/O) circuit 84, a data processor, such as a central processing unit (CPU) 86 (e.g., a microprocessor), and a memory 86 which typically includes both volatile memory and non-volatile memory. I/O circuit 84 is used to communicate information in appropriately structured form to and from other CPU 86 and other devices or networks external to system 80. CPU 86 is in communication with I/O circuit 84 and memory 88. These elements can be those typically found in most general purpose computers and are known per se.

A display device 90 is shown in communication with data processor 82, typically via I/O circuit 84. Data processor 82 issued to display device 90 graphical and/or textual output images generated by CPU 86. A keyboard 92 is also shown in communication with data processor 82, typically I/O circuit 84.

It will be appreciated by one of ordinary skill in the art that system 80 can be part of a larger system. For example, system 80 can also be in communication with a network, such as connected to a local area network (LAN), the Internet or a cloud computing resource of a cloud computing facility.

In some embodiments of the invention data processor 82 of system 80 is configured for receiving an initial contour defining the region in a first video frame of the video image, generating at least one candidate contour in a video frame F, analyzing, each candidate contour based on intensity values of picture-elements along said candidate contour, and analyzing an area at least partially enclosed by each candidate contour based on texture features in the area. Data processor 82 is also configured for selecting a winner contour from the candidate contour(s) based on the analyses, and associating the region with the winner contour. In some embodiments of the present invention data processor 82 is configured for stabilizing the video image as further detailed hereinabove and displaying the stabilized video image on display 90.

In some embodiments of the invention system 80 communicates with a cloud computing resource (not shown) of a cloud computing facility, wherein the cloud computing resource is configured for receiving an initial contour defining the region in a first video frame of the video image, generating at least one candidate contour in a video frame F, analyzing, each candidate contour based on intensity values of picture-elements along said candidate contour, and analyzing an area at least partially enclosed by each candidate contour based on texture features in the area. The cloud computing resource is also configured for selecting a winner contour from the candidate contour(s) based on the analyses, and associating the region with the winner contour. In some embodiments of the present invention the cloud computing resource is configured for stabilizing the video image as further detailed hereinabove and displaying the stabilized video image on display 90.

The method as described above can be implemented in computer software executed by system 80. For example, the software can be stored in of loaded to memory 88 and executed on CPU 86. Thus, some embodiments of the present invention comprise a computer software product which comprises a computer-readable medium, more preferably a non-transitory computer-readable medium, in which program instructions are stored. The instructions, when read by data processor 82, cause data processor 82 to receive the video image and the initial contour and execute the method as described above.

Alternatively, the computation capabilities of system 80 can be provided by dedicated circuitry. For example, CPU 80 and/or memory 96 can be integrated into dedicated circuitry configured for receiving an initial contour defining the region in a first video frame of the video image, generating at least one candidate contour in a video frame F, analyzing, each candidate contour based on intensity values of picture-elements along said candidate contour, and analyzing an area at least partially enclosed by each candidate contour based on texture features in the area. The dedicated circuitry is also configured for selecting a winner contour from the candidate contour(s) based on the analyses, and associating the region with the winner contour. In some embodiments of the present invention the dedicated circuitry is configured for stabilizing the video image as further detailed hereinabove and displaying the stabilized video image on display 90.

As used herein the term “about” refers to ±10%.

The word “exemplary” is used herein to mean “serving as an example, instance or illustration.” Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments.” Any particular embodiment of the invention may include a plurality of “optional” features unless such features conflict.

The terms “comprises”, “comprising”, “includes”, “including”, “having” and their conjugates mean “including but not limited to”.

The term “consisting of” means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Various embodiments and aspects of the present invention as delineated hereinabove and as claimed in the claims section below find experimental support in the following examples.

### Examples

Reference is now made to the following examples, which together with the above descriptions illustrate some embodiments of the invention in a non limiting fashion.

In the present example, an ROI tracking technique which is based on components of visual adaptation mechanisms, is described. The technique is described below with a particular emphasis to a cardiac MRI (CMR) perfusion image, but can be applied to any type of image, preferably a video image, more preferably an achromatic video image.

FIGS. 4A-D show several sequences of a CMRI perfusion image, also known as TC-Short-Axis. The image demonstrates the fast-varying texture and contour-shape of the heart.

### Method

The technique applied in the present example stabilized CMRI video images according to a given ROI. The technique consisted of a tracker, a motion estimator and a motion compensator. Video-stabilization was obtained by solving the ROI-tracking problem while keeping its initial position fixed. The ROI motion was then estimated by a linear approximation (translation, rotation, scale), and was used for stabilization. Even though a translation component performs the transformation non-linearly, the approximation in the present example is termed ‘linear’.

The technique of the present embodiments combines information from both edge and region domains and adaptively weights them according to ROI current state. The technique used in the present example was autonomous, self-adapting and required no user-interference. This technique was found by the inventors to be robust to video type and sufficiently sensitive to objects motion. This technique was also found to be capable of handling occlusions and deformations.

The ROI in the present example was the heart. For some of the frames the heart has more prominent region characteristics (e.g., left and right ventricles). For other frames the heart has a more distinguishable occluding contour. It is often appears as a non-continuous contour, while some of its fragments are more prominent than the others.

Heart motion is complex due to different elements that contribute to the motion, among them are: (a) heart natural motion (heartbeats), (b) internal motion of inner organs and tissues parts and perfusion fluid motion within the heart, and (c) global motion due to patient respiration. The technique of the present example, preserves the motion elements (a) and (b) since they can aid radiological analysis, and removes motion element (c) since it typically disturbs the diagnosis.

The first motion element (a) was modeled as a scaling operation (contraction and relaxation), in addition to a small non-linear deformation (cardiac cycle). The second motion element (b) was considered as a varying texture. Note that the internal-motion is not common for all organs and tissues parts. The third motion element (c) was modeled as a translation in addition to rotation. According to this modeling scheme, the total motion of the heart can be written as follows:

I_{Heart}^{k+1}=f_{HNM}(f_{IM}(f_{GM}(I_{Heart}^{k}))) (EQ. 1.1)

where I_{Heart}^{k} is the current frame, I_{Heart}^{k+1} is the subsequent frame, f_{HNM} is the heart natural motion (scaling and deformations, nonlinear), f_{IM} is the texture change due to second kind of motion (nonlinear) and f_{GM} is the global motion to be compensated (rotation and translation, linear).

The stabilization goal was defined as keeping the ROI at a static position over all frames. Typically, this operation reduced or prevented motion interferences with the surrounding organs. The term “static position” as used in the present example refers to location and orientation, but not to scale operation. The stabilization was achieved using the following operator:

Stable[I_{Heart}^{k+1}]=f_{HNM}(f_{IM}(I_{Heart}^{k})) (EQ. 1.2)

The human vision system (HVS) is capable of tracking the fast-varying heart across the frames. Without wishing to be bound to any particular theory, it is postulated that the HVS adaptively weights the frame's information according to possible change in heart appearance at each frame. The heart has a clearer interior pattern at several frames, while at other frames it has a clearer occluding contour.

An additional observation is that the HVS efficiently performs heart boundaries determination so that the tracking is not disturbed by interior movement inside the heart. Without wishing to be bound to any particular theory, it is postulated that the human visual-system learns, on-the-fly, which of the information is more reliable and which one is less. It is postulated that the HVS analyzes the scene through several channels simultaneously, such as brightness and spacial frequency, so as to take advantage of all the available information pathways. The model of the present example utilizes the neuronal receptive-fields (RF), which perform oriented edge detection, through mainly the RF of simple cells in areas V1 and V2.

The goal of the technique of the present example is to perform stabilization through tracking the heart at each frame, then analyzing and compensating its motion comparing to first-frame position. Consequently, the stabilization problem is formulated and solved as a tracking problem.

The technique of the present example receives, as inputs, a CMRI video and an initial ROI marking. The output of the technique is a generally stabilized video.

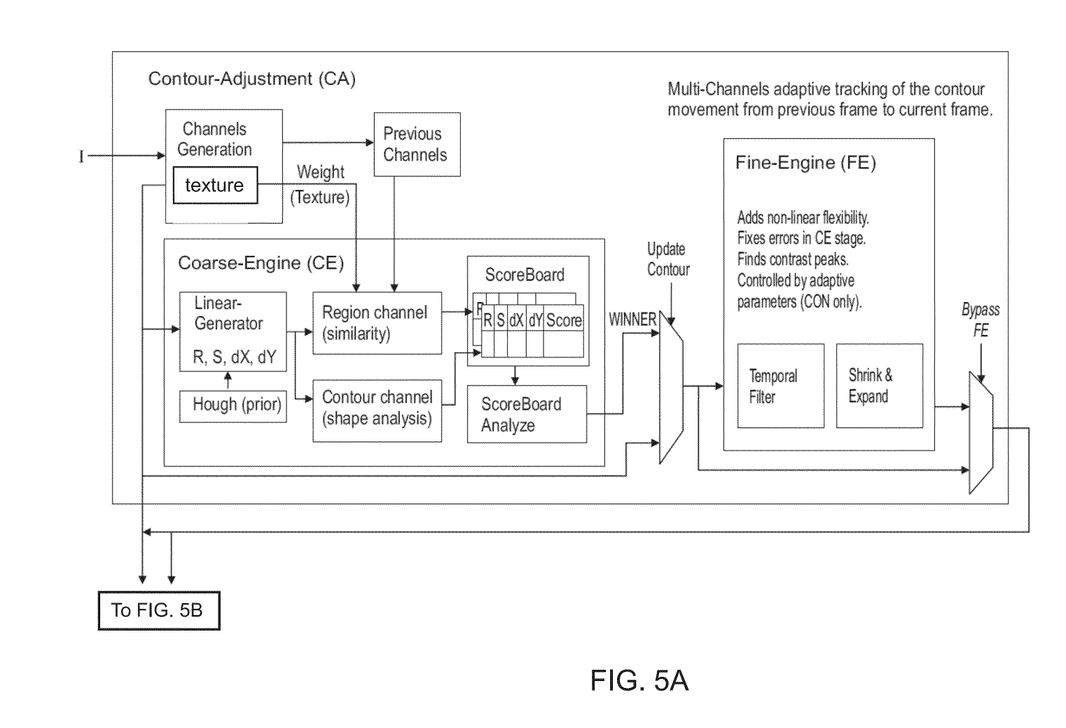

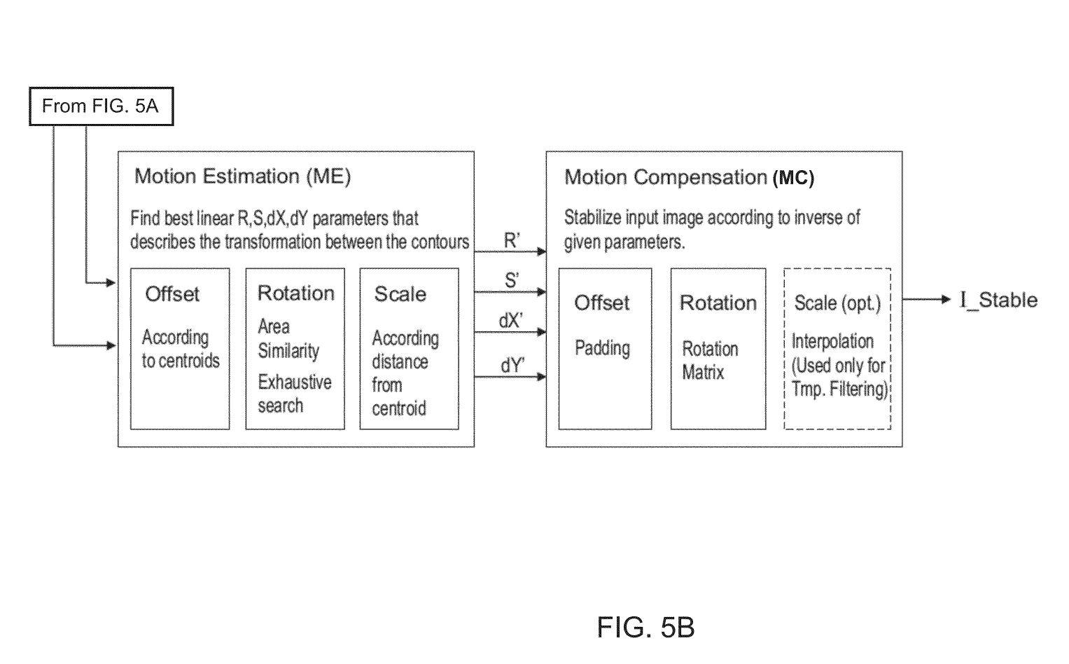

FIGS. 5A-B depict an imaging processing apparatus used in the present example. Each input frame is first split into two separated feature channels, brightness and texture. The brightness channel is further split into two additional channels, edge and region (“Channels Generation”).

A linear contour generator (“Coarse Engine”, CE) manipulates (rotation, R, scale, S, and offset, dX, dY) the previous-frame's contour, to find the best candidate for the current frame. This is done iteratively over the frames. Each such manipulation provides a weighted score, which is written into a designated scoreboard. The derived contour, which gets highest score, optionally enters a non-linear contour generator (“Fine Engine”, FE). The FE allows deformations and a higher resolution than the CE, for motion estimation. The algorithm flow is controlled automatically by an adaptive controller.

The coarse engine runs an exhaustive search for finding the best contour candidate in current frame. The search covers different domains, including rotations (R, typically expressed as rotation angles), scales (S) and offsets (dX, dY) of previous-frame contour (see, EQ. 1.3). A hough sub-engine (HSE) is used for injecting a priory information (prior) into the linear generator. The HSE seeks for prominent lines in the current frame (in a certain window) and adds their relative rotations into the linear generator search space.

The HSE acts as a generic option for injecting priors for the algorithm. It cannot deteriorate the stabilization results, even if the prior is wrong, since the HSE only expands the search-space of the CE by adding more candidates to be examined. Thus, the HSE improves the tracking precision.

The operation of the linear generator can be described mathematically as follows:

$$( EQ . 1.3 )$$

$$\{ \begin{matrix}{C}_{A} = {Contour}_{Area} = \frac{1}{2} \cdot {\sum }_{i = 0}^{N - 1} ( {x}_{i} {y}_{i + 1} - {x}_{i + 1} {y}_{i} ) \\ {C}_{X} = {Contour}_{Centroid}^{X} = \frac{1}{6 \cdot {C}_{A}} \cdot {\sum }_{i = 0}^{N - 1} ( {x}_{i} + {x}_{i + 1} ) ( {x}_{i} {y}_{i + 1} - {x}_{i + 1} {y}_{i} ) \\ {C}_{Y} = {Contour}_{Centroid}^{Y} = \frac{1}{6 \cdot {C}_{A}} \cdot {\sum }_{i = 0}^{N - 1} ( {y}_{i} + {y}_{i + 1} ) ( {x}_{i} {y}_{i + 1} - {x}_{i + 1} {y}_{i} )\end{matrix} \\ {Rot}_{θ} = [ \begin{matrix}cos ( θ ) & - sin ( θ ) & {C}_{X} \cdot [ 1 - cos ( θ ) ] + {C}_{Y} \cdot sin ( θ ) \\ sin ( θ ) & cos ( θ ) & {C}_{Y} \cdot [ 1 - cos ( θ ) ] + {C}_{X} \cdot sin ( θ ) \\ 0 & 0 & 1\end{matrix} \\ {Contour\_Rot}_{θ} = {Rot}_{θ} \cdot {[ \begin{matrix}Contour \\ 1\end{matrix} ]}_{3 \times N} ≡ {[ \begin{matrix}CR\_row 1 \\ CR\_row 2 \\ CR\_row 3\end{matrix} ]}_{3 \times N} \\ {Contour}_{OUT}^{X} = {C}_{X} + S \cdot ( CR\_row 1 - {C}_{X} ) + dX \\ {Contour}_{OUT}^{Y} = {C}_{Y} + S \cdot ( CR\_row 2 - {C}_{Y} ) + dY$$

where θ is the rotation angle relative to the X axis, where the input contour is represented as [xᵢ, yᵢ]ᵢ₌₀^{N}, where the area and centroid of the contour are extracted as C_{A} and [Cₓ,C_{y}] respectively, and where the output of the linear generator is declared as [Contour_{OUT}^{X},Contour_{OUT}^{Y}]ᵢ₌₀^{N}.

The output of the linear generator output is used for analyzing each frame in two separate channels: contour channel (shape analysis, SA) and region channel (Inter Frames Similarity, IFS).

The contour channel is useful for extracting information that resides on the boundary of the ROI, and the region channel is useful for extracting information that resides in the inner area of the ROI. Use of both contour and region channels allows the flexibility of giving different weights for region and contour channels during later adaptive processing.

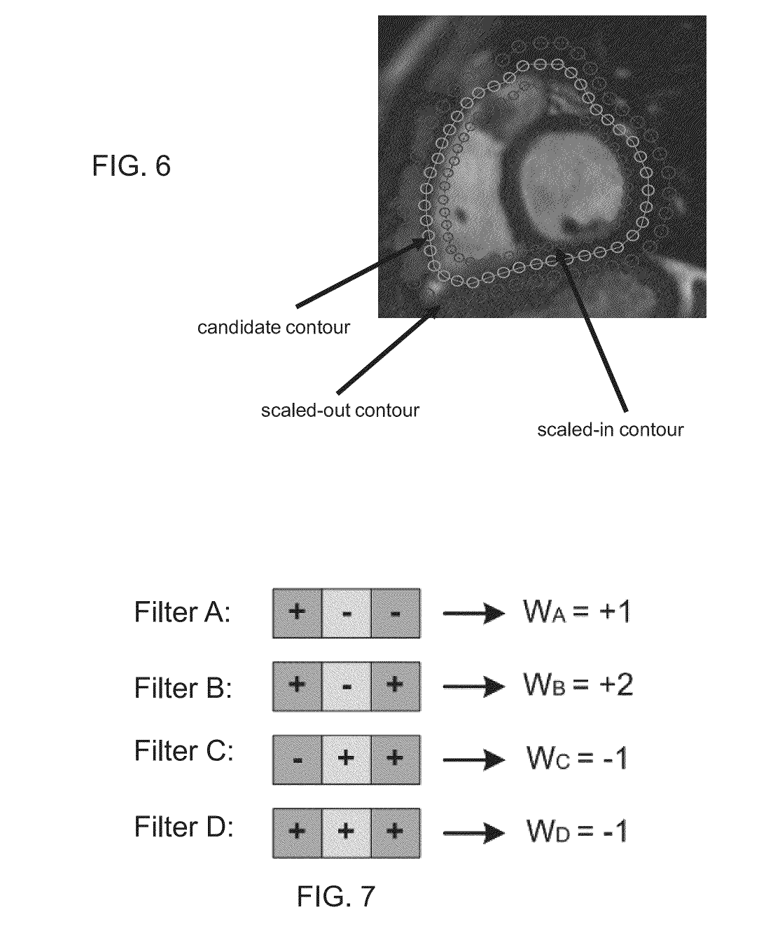

The SA was done using filters which are similar to RF of the HVS. In a first stage of the SA, scaled-in (90%) and scaled-out (%110) versions of the candidate contour were generated. This is illustrated FIG. 6. In a second stage of the SA, each pixel of the original contour as well as its scaled-in and scaled-out versions was replaced with a sampling feature (f_{m,n}) of its 11×11 neighborhood, as follows:

f_{m,n}^{(k)}=I_{11×11}(m,n)·G_{11×11}(0,1) (EQ. 1.4)

where f_{m,n}^{(k)} is the kth sampling feature of the contour which is located at coordinates (m, n) in the frame, I_{11×11}(m,n) is a neighborhood region of the frame using an 11×11 window surrounding (m, n) and G_{11×11} (0,1) is a 11×11 Gaussian matrix with kernel 0,1. This type of sampling extracts information from a region rather than from a single pixel, and is therefore advantageous since it reduces random noise effects. At this stage, each sampling feature on the contours represents a local characterization of its environment.

Once the SA was completed, a shape analysis score was calculated, as follows:

$${S}_{X} = {\sum }_{k} X \cdot {[ {C}_{1}^{( k )} , {C}_{2}^{( k )} , {C}_{3}^{( k )} ]}^{T} , X ∈ \{ A , B , C , D \} \\ {SCORE}_{SA} = {S}_{A} \cdot {W}_{A} + {S}_{B} \cdot {W}_{B} + {S}_{C} \cdot {W}_{C} + {S}_{D} \cdot {W}_{D} \qquad ( EQ . 1.5 )$$

where the summation S_{X} is an intermediate score which obtained using four filters A, B, C and D, separately for the kth sampling feature, C₁, C₁ and C₃ are the scaled-in, original and scaled-out contours after the sampling procedure, and W_{X} is a weight associated with filter X. The filters A, B, C and D and respective weights W_{A}, W_{B}, W_{C} and W_{D} are illustrated in FIG. 7. The filters are similar to the filter used by HVS, and were applied mathematically as 1×3 vectors, expressed as [1,−1,−1], [1,−1,1], [−1,1,1] and [1,1,1], respectively. The weights W_{X} were selected such as to credit features that are likely to be located on the edge (filter A) or tunnels (filter B), and also to assign penalty to features located at the external side of the edge (filter C), or the interior side of the edge (filter D).

Each intermediate score S_{X}, X=A, B, C, D was therefore obtained by calculating the inner product between the respective filter and its 3×1 contour vector, [C₁^{(k)},C₂^{(k)},C₃^{(k)}]^{T}.

IFS (see region channel in FIG. 5A) was done by checking how similar the region of the current frame was to the region in the previous frame. In this context, region refers to the interior of the contour. The current frame was registered to the previous frame coordination before the comparison between the two. The similarity was determined using linear estimation. Several similarity measures were examined. These included Sum of Squared Differences (SSD) based on mean squared error (MSE), Multi-scale Structural Similarity (MSSIM) and Mutual Information (MI). The similarity between the two regions was analyzed using a weighting mask based on a range filter. A range filter assigns greater coefficients to neighboring pixels with light intensity that is more similar to the center pixel value. In the present example the range filter replaced the intensity value of each pixel p with the difference between the maximal intensity value and the minimal intensity value over a group G of pixels containing pixel p. The group G was selected to be an 11×11 square of pixels the center of which being the pixel p. Use of a range filter enabled enhancing different textures by their edges. The motivation for that was to enhance lines and gaps between the lines that the visual system perceives them as real contours or continuous fragment in a given texture.

This leads also to enhancement of reliability of features which are part of lines in the image and therefore might be representing further important information.

Once the IFS was completed, an IFS score was calculated, as follows:

$${SCORE}_{IFS} = \{ \begin{matrix}- {\sum }_{\begin{matrix}All features \\ in the region\end{matrix}} {[ W \cdot ( T [ {R}_{curr} ] - {R}_{prev} ) ]}^{2} , & mode = MSE \\ - 1 / MSSIM ( W \cdot T [ {R}_{curr} ] , W \cdot {R}_{prev} ) , & mode = MSSIM \\ - 1 / MI ( W \cdot T [ {R}_{curr} ] , W \cdot {R}_{prev} ) & mode = MI\end{matrix} \qquad ( EQ . 1.6 )$$

where W presents the weighting mask calculated for the current frame ROI (a range filter in the present example), Rₚᵣₑᵥ presents the previous frame region matrix, and T[R_{curr}] presents the current frame region matrix after registration (T[•]). W, Rₚᵣₑᵥ and R_{curr} are all matrices with the region's dimension.

The SA score and IFS score were written in a designated scoreboard, together with the respective parameters of the generator. A schematic representation of a scoreboard, suitable to the present embodiments is provided in Table 1:

TABLE 1

| Contour | | | Offset | Offset | SA | IFS |
|---|---|---|---|---|---|---|
| No. | Rotation | Scale | X | Y | Score | Score |
| 1 | . . . | . . . | . . . | . . . | . . . | . . . |
| 2 | . . . | . . . | . . . | . . . | . . . | . . . |

The best candidate contour was chosen using a statistical analysis of the scoreboard. Score weights of both contour and region channels were applied on-the-fly according to a score variance, defined as the score subtractions over four best sequential scorings, for each scoring type.

High score variance implies that the respective score type is applicable to the current frame, and low score variance implies that the respective score type is less suitable for the current frame. Algorithm 1, below, is a pseudo code describing the procedure used for extracting the best candidate (referred to below as “winner contour”) from the scoreboard. This algorithm is generic and is useful for a general scenario of which several candidates have multiple scores.

$$Algorithm 1$$

$$1 \text{:} SB\_SA = Norm \{ SB ( : , : , : , : , 1 ) \}$$

$$2 \text{:} SB\_IFS = Norm \{ SB ( : , : , : , : , 2 ) \}$$

$$3 \text{:} A ← Sort \{ SB\_SA , {}_{}^{‵}{descend}{}_{}^{′} \}$$

$$4 \text{:} B ← Sort \{ SB\_IFS , {}_{}^{‵}{descend}{}_{}^{′} \}$$

$$5 \text{:} W = [ 4 \; 2 \; 1 ] \cdot [ \begin{matrix}\vert A ( 2 ) - A ( 1 ) \vert & \vert B ( 2 ) - B ( 1 ) \vert \\ \vert A ( 3 ) - A ( 2 ) \vert & \vert B ( 3 ) - B ( 2 ) \vert \\ \vert A ( 4 ) - A ( 3 ) \vert & \vert B ( 4 ) - B ( 3 ) \vert\end{matrix} ]$$

$$6 \text{:} Unified\_SB = W ( 1 ) \cdot SB\_SA + W ( 2 ) \cdot SB\_IFS$$

$$7 \text{:} Winner\_Parameters = {argmax}_{Rot , Scl , OffX , OffY} Unified\_SB$$

In Algorithm 1, lines 1-4 represent a sorting phase. SB_SA and SB_IFS contain normalized scoreboards for SA and IFS, respectively. These two scoreboards are then sorted in a descending order (A, B). The normalization operation is preferred since the two scoreboards may be in different scales. Norm{•} is a standard [0,1] normalization operator, and Sort{•, ‘descend’} is a sorting operator in a descending order.

Lines 5-6 of Algorithm 1 calculate a weight vector W that weighs the scoreboards SB_SA and the SB_IFS. The weight vector is calculated based on the differences of the first 4-order elements in both scoreboards (score variance). A unified scoreboard is than generated by merging SB_SA and SB_IFA using the calculated weight vector W.

Line 7 of Algorithm 1 extracts the parameters which best approximate the linear transformation over the two sequential frames as the arguments that correspond with the maximal score in the unified scoreboard.

In the present example, winner candidate entered a Fine Engine (FE) which added non-linear flexibility and corrected errors. The FE included an operation referred to herein as “Shrink And Expand”. This operation was based on an observation made by the present inventors according to which the ROI boundaries at the current frame can be determined by a small variation from the winner contour obtained by the CE. The Shrink And Expand operation is illustrated in FIG. 8, which shows the ROI boundary of the current frame, the CE-Winner and the shrunk and the expanded contours. The ROI position is searched along the paths marked by the outgoing arrows from the shrunk version of the CE winner contour to its expanded version.

Algorithm 2, below, is a pseudo code describing the procedure used for the Shrink And Expand operation.

### Algorithm 2

1. Generate shrunk and expanded versions of the CE-winner contour, e.g. 90% and 110% of the CE winner, correspondingly.
2. Connect matching points across shrunk and expanded contours with straight paths.
3. Sample current frame along the shrink-to-expand paths, and smooth it using an average filter (LPF).
4. Generate a deformation probability, P(x), based on features weights, according to the following Equation:

$${P}_{k} ( x ) = exp \{ - {[ \frac{β \cdot \sqrt{{W}_{k}} \cdot ( x - L / 2 )}{L / 2} ]}^{2} \} \qquad ( EQ . 1.7 )$$

where Wₖ is the weight of the k feature (based on SCORE_{SA}, see EQ. 1.5), x ε[0, L] is the location between the shrink contour (x=0) and the expanded contour (x=L), and β is a normalization factor. All of the above are scalars. The highest probability for any feature is its CE-winner match (x=L/2), and the probability decays according to the feature's weight.
5. For each feature do:
   Find highest edges over each path (gradient peaks).
   Find brightness peaks over each path.
   Find previous neighbor deformation and/or reallocation:
   Note that the deformation probability from 4 above is used as a masking weight for each of these criterion findings, separately.
6. Reallocate points as a soft decision based on 5.
7. Smooth across the features at the features plane.
8. Interpolate across the features at the features plane.

The Shrink And Expand operation is a computationally fast tool which respects orientations, since deformations are searched perpendicular to the linear prediction (CE winner). This approach can be viewed as an edge detection phase in a highly textured domain. The Shrink And Expand approach handles texture under the assumption that the highest peaks in brightness and edges are due to the real ROI boundaries (Algorithm 2, 5). A prominent texture adjacent to the CE-winner might generate outliers, and thereby causes a wrong contour adjustment. Therefore, a temporal filtering was used in order to smooth textural interior patches. FIG. 9 illustrates the temporal filtering employed in the present example. The temporal filtering was employed over three sequential frames and assumed texture variation and fixed boundary over that temporal window. This filter used feedback from last two previous frames, in order to initiate the filtering over the same ROI position.

The output of the FE operation entered a Motion Estimation (ME) stage (FIG. 5B). The ME received two contours as input: ROI positions at the current frame and ROI positions at the previous frame. The output was an approximation of the best linear affine transformation describing the transition between the two contours. The approximation was expressed in terms of the offset, rotation and scale parameters. When FE was deprecated, the ME output was the parameters of the CE winner contour.

For the offset parameters calculation, the ME calculated a centroid for an N-degree closed polygon as follows:

$${C}_{x} = \frac{1}{6 A} \cdot {\sum }_{i = 0}^{N - 1} ( {x}_{i} + {x}_{i + 1} ) \cdot ( {x}_{i} {y}_{i + 1} - {x}_{i + 1} {y}_{i} ) \\ {C}_{y} = \frac{1}{6 A} \cdot {\sum }_{i = 0}^{N - 1} ( {y}_{i} + {y}_{i + 1} ) \cdot ( {x}_{i} {y}_{i + 1} - {x}_{i + 1} {y}_{i} ) \\ A = \frac{1}{2} \cdot {\sum }_{i = 0}^{N - 1} ( {x}_{i} {y}_{i + 1} - {x}_{i + 1} {y}_{i} ) \qquad ( EQ . 1.8 )$$

where the polygon is represented as [xᵢ, yᵢ]ᵢ₌₀^{N}, A is its area, and [Cₓ, C_{y}] are the centroid coordinates.

For the rotation parameters, the ME also employed an exhaustive search over π radians with a half radian resolution. Region Intersection (RI) similarity was used for choosing the best rotation candidate. This is illustrated in FIG. 10 which describes two contours denoted A and B. A candidate was considered as adequate for a rotation transformation over the two, when it has a high true positive (TP) area, a low sum of false negative (FN) and false positive (FP) areas. For each rotation candidate contour, an RI score was calculated as follows:

RI=TP−(FP+TN) (EQ. 1.9)

The estimated rotation parameter was selected according to the highest score.

For the scale parameter, the ratio between the mean distances from each centroid to its occluding boundaries was calculated, as follows:

$$Scale = \frac{\frac{1}{{N}^{( 1 )}} \cdot {\sum }_{i = 1}^{{N}^{( 1 )}} \sqrt{{( {C}_{x}^{( 1 )} - {x}_{i}^{( 1 )} )}^{2} + {( {C}_{y}^{( 1 )} - {y}_{i}^{( 1 )} )}^{2}}}{\frac{1}{{N}^{( 2 )}} \cdot {\sum }_{i = 1}^{{N}^{( 2 )}} \sqrt{{( {C}_{x}^{( 2 )} - {x}_{i}^{( 2 )} )}^{2} + {( {C}_{y}^{( 2 )} - {y}_{i}^{( 2 )} )}^{2}}} \qquad ( EQ . 1.10 )$$

The linear affine transformation calculated by the ME entered into a motion compensation stage. In the motion compensation stage, a stabilized version of the frame was generated by an inverse affine transformation, which is based on the translation and rotation estimations from the ME stage. The scale component was not compensated, since all scale changes were assumed to be derived from heart natural motion (heartbeats), which were not removed in this example.

### Results

Three time sequences of TC-short-axis CMRI images were acquired from 10 patients. Each sequence contains about 40 frames (images from different depths). All of the CMRI videos, and the corresponding diagnoses, have been received from Sheba Medical Center, Israel.

Several techniques were tested as a comparative study. The following notations will be used as abbreviations for the tested techniques.

B=Lucas-Kanada-Tomasi (LKT) [Tomasi, Carlo, and Takeo Kanade. Detection and tracking of point features. Pittsburgh: School of Computer Science, Carnegie Mellon Univ., 1991]

C=Template Matching (TM) [Lucas, Bruce D., and Takeo Kanade. “An iterative image registration technique with an application to stereo vision.” IJCAI. Vol. 81. 1981]

D=Adobe Premiere Pro CC [Greenberg, Jeff I., et al. Adobe Premiere Pro Studio Techniques. Adobe Press, 2013]

E=YouTube stabilizer [Grundmann, Matthias, Vivek Kwatra, and Irfan Essa. “Auto-directed video stabilization with robust 11 optimal camera paths.” Computer Vision and Pattern Recognition (CVPR), 2011 IEEE Conference on. IEEE, 2011]

F=A Commercially available tool known as Deshaker, version 3.0

G=The technique described in the Method section, using MSE similarity for IFS (EQ. 1.6)

H=The technique described in the Method section, using MSSIM similarity for IFS (EQ. 1.6)

In addition, the notation “A” will be used as a reference to the input video.

The following parameters were employed for techniques G and H:

Contour resolution: 50 features, window-size 11×11.

CE engine search-space:
3 Rotation values: 0, ±π/32.
3 scale value: 0.95, 1.00, 1.05.
9 translation values: 0, ±1, ±2, ±3, ±4.
Number of iterations per frame: 3²×9².

FE-engine search-space:
Shrink factor: 0.8
Expand factor: 1.2.

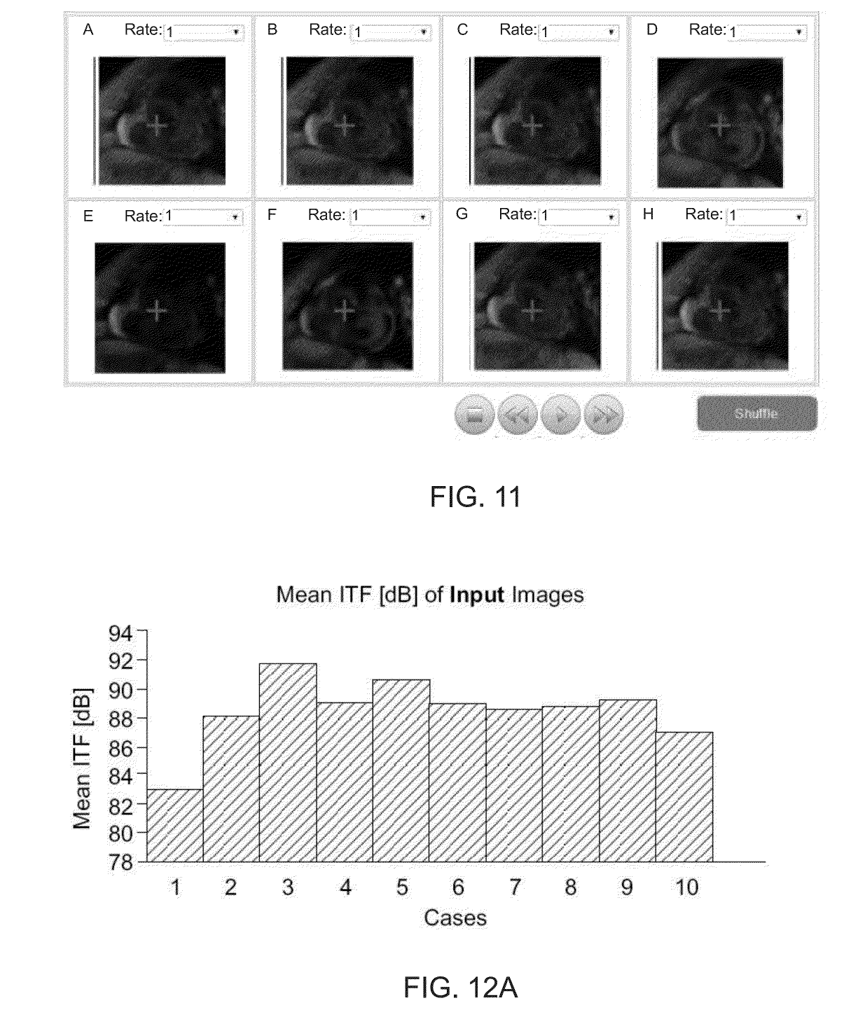

The comparative study included two types of assessments: clinical assessment and engineering assessment. The clinical assessment consisted of 2 expert CMRI radiologists with clinical experiences of 8 and 11 years. The experts were requested to review the 10 different videos for each patient. Each CMRI patient's video was introduced to the radiologists for clinical evaluation in a single 2×4 windows matrix presentation, as shown in FIG. 11, where the notations A-H are as described above. The radiologists' evaluation was initiated after a random shuffling of the video windows. The radiologists were then asked to rate the different windows from 1 (less stable) to 5 (most stable). The engineering assessment compared tools G and H to the input only. Engineering scores were calculated according to the Inter-Frame-Similarity (ITF) and the Structural Similarity (SSIM) stability gains, as follows:

$$Gain\_ITF = \frac{\frac{1}{N} {\sum }_{k} ITF \{ OutFrame ( k ) \}}{\frac{1}{N} {\sum }_{k} ITF \{ InFrame ( k ) \}} \\ Gain\_SSIM = \frac{\frac{1}{N} {\sum }_{k} MSSIM \{ OutFrame ( k ) \}}{\frac{1}{N} {\sum }_{k} MSSIM \{ InFrame ( k ) \}} \qquad ( EQ . 1.11 )$$

where InFrame and OutFrame refer for the original video and the stabilized video respectively. ITF{•} was implemented as PSNR between successive frames, as follows:

$$ITF [ {I}_{curr} ] = 20 {log}_{10} [ \frac{255 \cdot NumOfPixels ( {I}_{curr} )}{\sqrt{{\sum }_{m , n} {( {I}_{curr} [ m , n ] - {I}_{prev} [ m , n ] )}^{2}}} ] \qquad ( EQ . 1.12 )$$

where I_{cuff} and Iₚᵣₑᵥ refer for the current and previous frames respectively.

MSSIM{•} was implemented as described in Wang, Zhou, et al. “Image quality assessment: from error visibility to structural similarity.” Image Processing, IEEE Transactions on 13.4 (2004): 600-612.

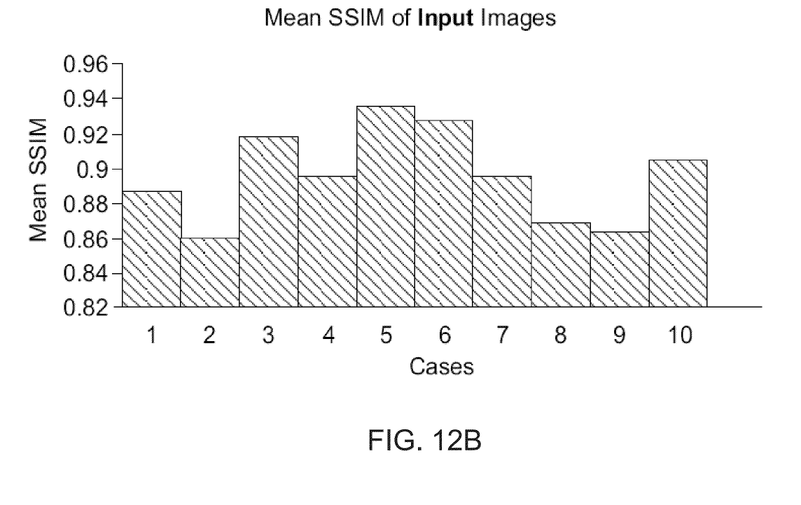

FIGS. 12A-B describe the mean ITF and the mean SSIM of the input videos. Videos which obtained a higher value are more stable (EQ. 1.11). It is observed that: (i) cases #3, #5 and #6 are most stable, (ii) these 2 similarity measures are not fully correlated, and (iii) SSIM appears to be a more sensitive measure.

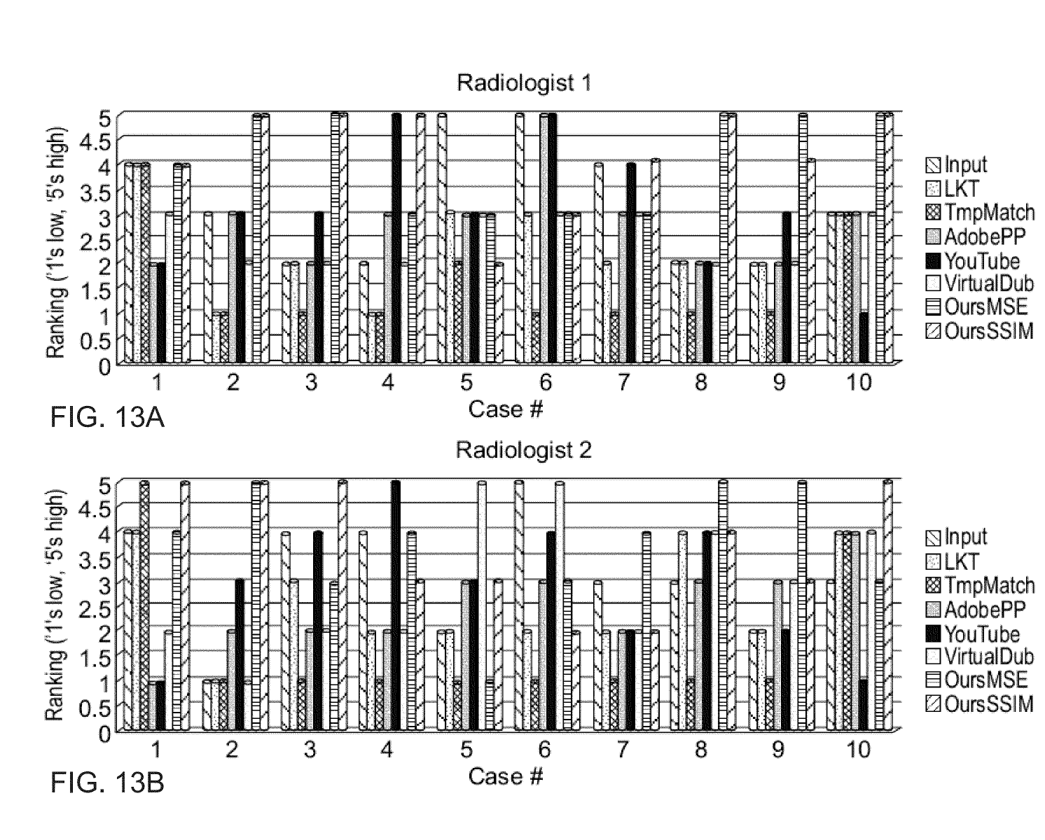

FIGS. 13A-B show the clinical assessment results, as described above. The horizontal axis lists the 10 different cases and the vertical axis shows the retrieved rankings. Each hatching represents a different technique, as described above. It is observed that the techniques of the present embodiments (denoted OursMSE and OursSSIM in FIGS. 13A-B were preferred by both radiologists for all cases, except case 5 and case 6. It is assumed that the reason for the reduced score of these cases is derived from the high natively stable nature of these videos (see FIGS. 12A-B). In such a case, the improvement falls within the discrete noise level, so that the CE winner is not sufficiently pronounced in the scoreboard.

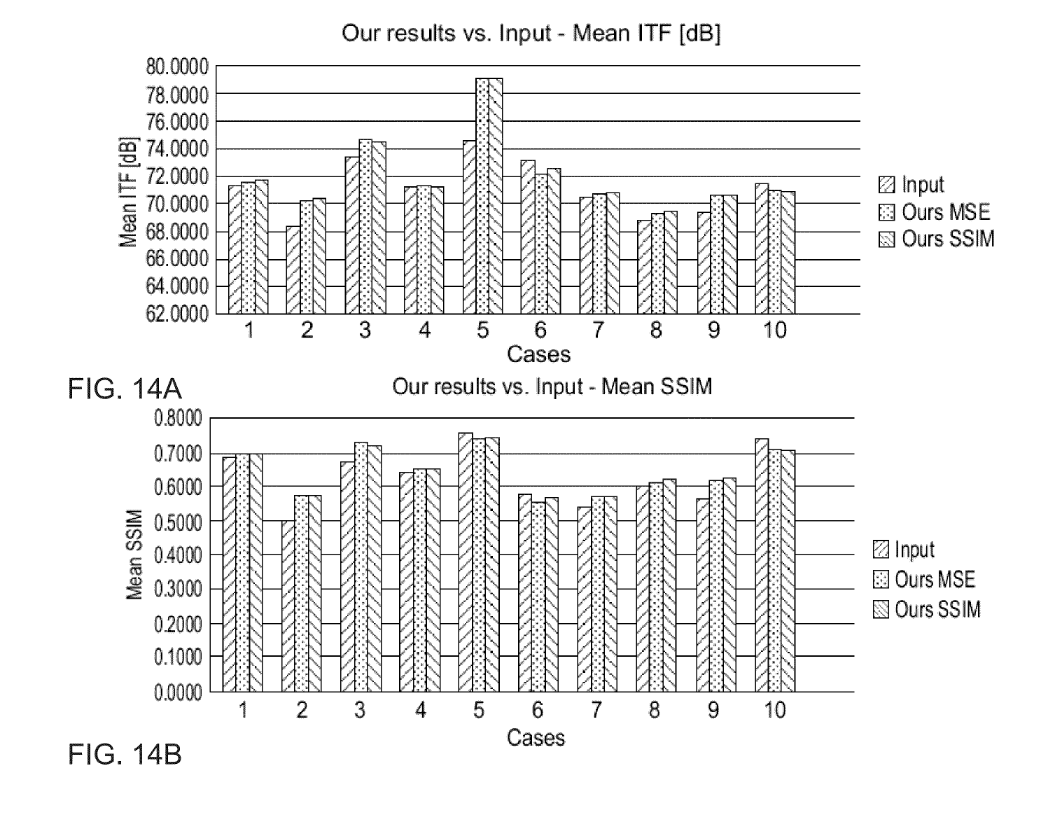

FIGS. 14A-B show the engineering stability gains (EQ. 1.11). It is observed that the techniques of the present embodiments were preferred for all cases except case 5, case 6 and case 10. Note that case 10 was found to be more stable according to the clinical assessment, but not according to the engineering assessment. This is due to the fast varying texture of the input video, so that the differences between sequential frames are not small for this case, and might cause a bias for the ITF and SSIM measurements. Further adaptive weighting techniques, such as range filtering, can be applied to obtain better engineering measurements.

The CE can be configured to use a specific similarity measure (EQ. 1.6). The results were focuses on MSE and SSIM. These two configurations gave similar results for both the engineering and the clinical assessments. The MSE and SSIM are more distinguishable in the clinical assessment.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

### REFERENCES

Marcenaro, Lucio, Gianni Vernazza, and Carlo S. Regazzoni. “Image stabilization algorithms for video-surveillance applications.” Image Processing, 2001. Proceedings. 2001 International Conference on. Vol. 1. IEEE, 2001.
Walha, Ahlem, Ali Wali, and Adel M. Alimi. “Video Stabilization for Aerial Video Surveillance.” AASRI Procedia 4 (2013): 72-77.
Zhu, J., Lao, Y. L. Y., & Zheng, Y. F. (2010). Object Tracking in Structured Environments for Video Surveillance Applications. IEEE Transactions on Circuits and Systems for Video Technology, 20.
Thiele, A., Dobkins, K. R., & Albright, T. D. (1999). The contribution color to motion processing in Macaque middle temporal area. The Journal of Neuroscience: The Official Journal of the Society for Neuroscience, 19, 6571-6587.
Jerosch-Herold, M., Seethamraju, R. T., Swingen, C. M., Wilke, N. M., & Stillman, A. E. (2004). Analysis of myocardial perfusion MRI. Journal of Magnetic Resonance Imaging, 19, 758-70.
Daly, C., & Kwong, R. Y. (2013). Cardiac MRI for myocardial ischemia. Methodist DeBakey Cardiovascular Journal, 9, 123-31
Cannons, K. (2008). A Review of Visual Tracking. Engineering, 242
Smeulders, N. W. M., Chu, D. M., Cucchiara, R., Calderara, S., Dehghan, A., & Shah, M. (2013). Visual Tracking: An Experimental Survey. IEEE Transactions on Pattern Analysis and Machine Intelligence.
Yilmaz, A. Javed, O., & Shah, M. (2006). Object tracking: A survey. ACM Computing Surveys, 38, 13.
Trucco, E., & Plakas, K. (2006). Video Tracking: A Concise Survey. IEEE Journal of Oceanic Engineering, 31.
Zhu, J., Lao, Y. L. Y., & Zheng, Y. F. (2010), Object Tracking in Structured Environments for Video Surveillance Applications. IEEE Transactions on Circuits and Systems for Video Technology, 20.
Weng, S., Kuo, C., & Tu, S. (2006). Video object tracking using adaptive Kalman filter. Journal of Visual Communication and image Representation, 17, 1190-1208.
Suryanto, Kim, D. H., Kim, H. K., & Ko, S. J. (2011). Spatial color histogram based center voting method for subsequent object tracking and segmentation. Image and Vision Computing, 29, 850-860.
Colantonio, S., Moroni, D., & Salvetti, O. (2005). MRI left ventricle segmentation and reconstruction for the study of the heart dynamics. Proceedings of the Fifth IEEE International Symposium on Signal Processing and Information Technology, 2005.
Kaus, M. R., von Berg, J., Weese, J., Niessen, W., & Pekar, V. (2004). Automated segmentation of the left ventricle in cardiac MRI. Medical Image Analysis, 8, 245-254.
Hui Wang, & Amini, A. A. (2012). Cardiac Motion and Deformation Recovery From MRI: A Review, IEEE Transactions on Medical Imaging.
Bogatyrenko, E., & Hanebeck, U. D. (2011). Visual stabilization of beating heart motion by model-based transformation of image sequences. Proceedings of the 2011 American Control Conference, 5432-5437.
Shechter, G., Ozturk, C., Resar, J. R., & McVeigh, E. R. (2004). Respiratory motion of the heart from free breathing coronary angiograms. IEEE transactions on medical imaging (Vol. 23, pp. 1046-1056).
Burger, I., & Meintjes, E. M. (2012). Elliptical subject-specific model of respiratory motion for cardiac MRI. Magn. Resort. Med., 000, 1-10.
Ventura, R. M. F. i, Hoogendoorn, C., Sukno, F. M., & Frangi, A. F. (2010), Bilinear point distribution models for heart motion analysis. Biomedical Imaging: From Nano to Macro, 2010 IEEE International Symposium on.
Hui Wang, & Amini, A. A. (2012). Cardiac Motion and Deformation Recovery From MRI: A Review. IEEE Transactions on Medical Imaging.
Xue, H., Zuehlsdorff, S., Kellman, P., Arai, A., Nielles-Vallespin, S., Chefdhotel, C., . . . Guehring, J. (2009). Unsupervised inline analysis of cardiac perfusion MRI. Medical Image Computing and Computer-Assisted Intervention: MICCAI . . . International Conference on Medical Image Computing and Computer-Assisted Intervention, 12, 741-749.
Dey, J., Pan, T. P. T., Smyczynski, M., Pretorias, H., Choi, D., & King, M. A. (2005). Investigation of respiration motion of the heart based on semi-automated segmentation and modeling of respiratory-gated CT data. IEEE Nuclear Science Symposium Conference Record, 2005, 5.
Lesica, N. A., Boloori, A. S., & Stanley, G. B. (2003). Adaptive encoding in the visual pathway. Network, 14, 119-135.
Carrasco, M. (2011). Visual attention: The past 25 years. Vision Research.
Schiller, P. H. (2010). Parallel information processing channels created in the retina. Proceedings of the National Academy of Sciences of the United States of America, 107, 17087-17094.
Lindeberg, T. (2013). A computational theory of visual receptive fields. Biological Cybernetics, 107, 589-635.
Freixenet, J., Mu, X., Raba, D., Mart, J., & Cuf, X. (2002). Yet Another Survey on Image Segmentation: Region and Boundary Information Integration. Springer-Verlag Berlin Heidelberg, 408-422.
Sebe, Nicu, Michael S. Lew, and Dionysius P. Huijsmans. “Toward improved ranking metrics.” Pattern Analysis and Machine Intelligence, IEEE Transactions on 22.10 (2000): 1132-1143.
Rouse, D. M., & Hemami, S. S. (2008). Understanding and simplifying the structural similarity metric. 2008 15th IEEE International Conference on Image Processing.
Walters-Williams, J., &. Li, Y. (2009). Estimation of Mutual Information: A Survey. Rough Sets and Knowledge Technology, 5589, 389-396. doi:10.1007/978-3-642-02962-2_49
Barkan, Yuval, Hedva Spitzer, and Shmuel Einay. “Brightness contrast-contrast induction model predicts assimilation and inverted assimilation effects.” Journal of Vision 8.7 (2008): 27.
Movahedi, Vida, and James H. Elder. “Design and perceptual validation of performance measures for salient object segmentation.” Computer Vision and Pattern Recognition Workshops (CVPRW), 2010 IEEE Computer Society Conference on. IEEE, 2010.
Tomasi, Carlo, and Takeo Kanade. Detection and tracking of point features. Pittsburgh: School of Computer Science, Carnegie Mellon Univ., 1991.
Lucas, Bruce D., and Takeo Kanade. “An iterative image registration technique with an application to stereo vision.” IJCAI. Vol. 81. 1981.
Greenberg, Jeff I., et al. Adobe Premiere Pro Studio Techniques. Adobe Press, 2013.
Grundmann, Matthias, Vivek Kwatra, and Han Essa. “Auto-directed video stabilization with robust 11 optimal camera paths.” Computer Vision and Pattern Recognition (CVPR), 2011 IEEE Conference on. IEEE, 2011.
Wang, Zhou, et al. “Image quality assessment: from error visibility to structural similarity.” Image Processing, IEEE Transactions on 13.4 (2004): 600-612

1. A method of tracking a region in a video image, the video image having a plurality of video frames, the method comprising:
receiving an initial contour defining the region in a first video frame of the video image; and
for each video frame F other than said first video frame:
generating at least one candidate contour in said video frame F;
for each candidate contour, analyzing said candidate contour based on intensity values of picture-elements along said candidate contour, and analyzing an area at least partially enclosed by said candidate contour based on texture features in said area; and
selecting a winner contour from said at least one candidate contour based on said analyses, and associating the region with said winner contour.

2. The method of claim 1, wherein said generating at least one candidate contour comprises geometrically manipulating a contour defining the region in a previous video frame.

3. The method according to claim 1, wherein said analyzing said at least one candidate contour based on intensity values comprises calculating a shape score based on a neighborhood of said candidate contour.

4. The method according to claim 3, wherein said calculation of said shape score comprises rescaling said candidate contour at least once to provide at least one rescaled version of said candidate contour, and assigning a weight to each rescaled version or combination of rescaled versions.

5. The method according to claim 1, wherein said analyzing said area comprises calculating a similarity score based on similarity between said area and an area at least partially enclosed by a contour defining the region in said previous video frame.

6. The method of claim 1, further comprising calculating affine transformation describing a change of the region relative to a previous video frame, said change being indicative of a motion of the region.

7. The method of claim 6, further comprising compensating said video frame F for said motion.

8. The method of claim 7, wherein said affine transformation is characterized by a rotation, translation and rescaling.

9. The method of claim 8, wherein said compensation comprises executing an inverse affine transformation with respect to said rotation, and said translation, but not said rescaling.

10. The method according to claim 1, further comprising generating a shrunk version and an expanded version of said winner contour, and analyzing said shrunk and said expanded versions so as to correct errors in said winner contour.

11. The method according to claim 1, wherein said analyzing said at least one candidate contour based on intensity values comprises calculating a shape score based on a neighborhood of said candidate contour, and wherein said analyzing said area comprises calculating a similarity score based on similarity between said area and an area at least partially enclosed by a contour defining the region in said previous video frame.

12. The method according to claim 11, wherein said selecting said winner contour comprises generating an ordered list of shape scores and an ordered list of similarity scores, combining said lists, and selecting contour parameters that maximize said combined list.

13. The method of claim 12, further comprising weighting said lists prior to said combination.

14. The method of claim 13, wherein said weighting is based on variances of scores in said lists.

15. A method of tracking a region in a video image, the video image having a plurality of video frames, the method comprising:
receiving an initial contour defining the region in a first video frame of the video image; and
for each video frame F other than said first video frame:
geometrically manipulating a contour defining the region in a previous video frame to provide at least one contour candidate;
for each candidate contour, independently calculating a shape score based on a neighborhood of said candidate contour, and a similarity score based on similarity between an interior of said contour in said previous video frame and an interior of said candidate contour; and
selecting a winner contour for said video frame F based on said shape score and said similarity score, and associating the region with said winner contour.

16. The method of claim 15, further comprising calculating affine transformation describing a change of the region relative to said previous video frame, said change being indicative of a motion of the region.

17. The method of claim 16, further comprising compensating said video frame F for said motion.

18. The method of claim 17, wherein said affine transformation is characterized by a rotation, translation and rescaling.

19. The method of claim 18, wherein said compensation comprises executing an inverse affine transformation with respect to said rotation, and said translation, but not said rescaling.

20. The method according to claim 15, further comprising generating a shrunk version and an expanded version of said winner contour, and analyzing said shrunk and said expanded versions so as to correct errors in said winner contour.

21. The method according to claim 15, wherein said calculation of said shape score comprises rescaling said candidate contour at least once to provide at least one rescaled version of said candidate contour, and assigning a weight to each rescaled version or combination of rescaled versions.

22. The method according to claim 15, wherein said selecting said winner contour comprises generating an ordered list of shape scores and an ordered list of similarity scores, combining said lists, and selecting contour parameters that maximize said combined list.

23. The method of claim 22, further comprising weighting said lists prior to said combination.

24. The method of claim 23, wherein said weighting is based on variances of scores in said lists.

25. The method according to claim 1, wherein said image is an achromatic image.

26. The method according to claim 1, wherein said image is an image acquired by a medical imaging system.

27. The method according to claim 1, wherein said image is an MRI image.

28. The method according to claim 1, wherein the image is of at least one type selected from the group consisting of a visible light image, an X-ray image, a thermal image, a ultraviolet image, a computerized tomography (CT) image, a mammography image, a Roentgen image, a positron emission tomography (PET) image, a magnetic resonance image, an ultrasound image, an impedance image, and a single photon emission computed tomography (SPECT) image.

29. The method according to claim 1, wherein the image is a cardiac MRI perfusion image, and the region is a heart.

30. A computer software product, comprising a computer-readable medium in which program instructions are stored, which instructions, when read by a computer, cause the computer to execute the method according to claim 1.

31. A system for processing an image, the system comprises a data processor configured for executing the method according to claim 1.
